(19) United States
(12) Patent Application Publication
(10) Pub. No.: US 2013/0297498 A1
(43) Pub. Date: Nov. 7, 2013

(54) METHOD AND SYSTEM FOR PROVIDING BROADBAND ACCESS TO A PLURALITY OF CUSTOMERS

(71) Applicant: William A. NAZARET, Weehawken, NJ (US)

(72) Inventor: William A. NAZARET, Weehawken, NJ (US)

(21) Appl. No.: 13/464,408

(22) Filed: May 4, 2012

(51) Int. Cl. G06Q 20/14

(52) U.S. Cl. CPC G06Q 20/14
USPC 705/40

(57) ABSTRACT

A system for transferring web content between a customer's user terminal and a web service over the Internet including an access network connected to the user terminal, a proxy server connected to the access network and the Internet, and a billing system. The billing system maintains accounts for the customers, each account having a prepaid balance. When a request for content transfer is received by the proxy server, the proxy server determines the cost to the user terminal for presentation to the customer. If the customer elects to continue with the transfer, the cost is deducted from his account and the transfer is effectuated.

### BACKGROUND OF THE INVENTION

1. Field of the Invention

The present invention relates to a method, a system and a computer usable medium storing a set of programs for providing economical broadband access to the Internet, to a plurality of customers. In response to a request from the customer to upload or download Specific content, he/she is presented With cost information for carrying the content across the access network and the customer then has the choice of completing or not the request. At any point in time, the total amount of content that any customer is allowed to access is dependent on the “allowance” available in his respective account. In the case of a pre-paid customer, the allowance represents monetary units; that the customer deposited in his/her account and he has not spent yet. Alternatively, for customers who subscribe to the .Internet Service Provider under a post-paid plan, the allowance is represented by data capacity units (bytes, kilobytes, megabytes, gigabytes, etc) to be transmitted across the access network under the maximum limits established by network access provider.

2. Description of the Prior Art

The prevalent method of paying for content transferred to and from a content server to a customer over the Internet throughout the world (including but not limited to, North-America, Japan and Western Europe) is referred to as a post-paid service. A post-paid customer applies for an account with a service provider. The service provider approves the account if the customer is credit worthy. Thereafter, charges are entered on the account for each use of the service by the respective customer. Every month at the end of what is called “the billing cycle,” the customer gets a bill covering all the charges, and is expected to pay the bill within a predetermined grace period, by check, credit card, debit card, cash, etc. If the bill is not paid in time, the service provider may assess penalties and may suspend Internet service to the customer. After suspension, the customer may have to pay a restoration fee to re-start the Internet service. Very pertinent to this invention is the fact that although access to the network is billed on a usage basis, that is, each customer pays for service that he. uses and the more he uses the more he pays, there is sometimes a limit imposed by the service provider on the account to prevent that any individual customer unduly loads the network potentially affecting the ability of other users to utilize it.

Many of the customers who want and need access to the Internet are also cell phone or mobile phone users. A fundamental reason why broadband Internet access use in the world trails the use of cellular or mobile phones by far is that the majority of users of mobile telephony prefer to purchase pre-paid access and control tightly when and how they spend their pre-paid funds. The prevalent service models for post-paid broadband Internet access adapt very poorly to the mentality of pre-paid customers, because once a customer enters a particular web site of his choice there is no control on how much data will be downloaded from (or uploaded to) that site. Even in a post-paid service the customer cannot completely control the amount of data uploaded or downloaded to his terminal when the service is on to perform a particular task but this lack of control over the amount of data was of limited relevance until maximum usage caps were imposed by the service providers.

In the world of prepaid users two things are always certain: available funds are limited and therefore the heed for the user to control spending is imperative.

### SUMMARY OF THE INVENTION

The present invention provides in one embodiment a pre-paid service that forgoes completely the need for opening a credit-based account with a service provider. Instead it requires a customer to deposit funds a priori into ah account created by the service provider. Once the prepaid account is established, the customer is provided access to the Internet. Charges for accessing the Internet are withdrawn from the account as units-of-use as they are “consumed.” This method of billing is thus called pre-paid because the customer is paying in advance for the service; The unit-of-use may be measured in time (e.g., minutes, hours, days or even weeks). With content, however, it is more appropriate to the nature of broadband networks to bill customers for the actual amount of uploaded or downloaded data (measured in bytes, or multiples thereof, e.g., KB, MB, etc.). Very pertinent to this invention is the fact that pre-paid customers implicitly impose on themselves a limit on how much data they utilize based on the amount of funds they hold in their prepaid respective account.

It is a general object of the present invention to provide an access method, system and a computer usable medium containing instructions to manage the transfer of content over the Internet between a remote server and a customer's terminal in a manner which allow the customer to know at every time the cost of downloading or uploading different content components. Armed with the tools required to manage, the customer can actively manage the cost of transferring content from the Internet to his/her terminal. The customer may utilize tools that analyze content components, (such as text, audio, video, etc), tag each of them with information about their type and the cost of downloading or uploading them. Then the customer can proceed, and request only those content components that are interesting and affordable to him and thus minimize the cost of transferred content to and from a remote server.

In another embodiment, the system prequalifies the customer when establishing an account. In this case, prepayment is not necessary and the customer is billed for the delivered content.

### BRIEF DESCRIPTION OF THE DRAWINGS

FIG. 1 shows a prior art postpaid system to transfer content on the Internet;

FIG. 2 shows a pre-paid system to transfer content on the Internet in accordance with this invention;

FIG. 3 shows a flow chart illustrating the operation of the system of FIG. 2 for downloading of content from the Internet;

FIG. 4 shows a flow chart illustrating the; operation of the system of FIG. 2 for uploading information from a customer terminal to a server via the Internet; and

FIG. 5 shows a hand-held customer terminal with a screen showing the customer various segments for of a requested; content.

### DETAILED DESCRIPTION OF THE INVENTION

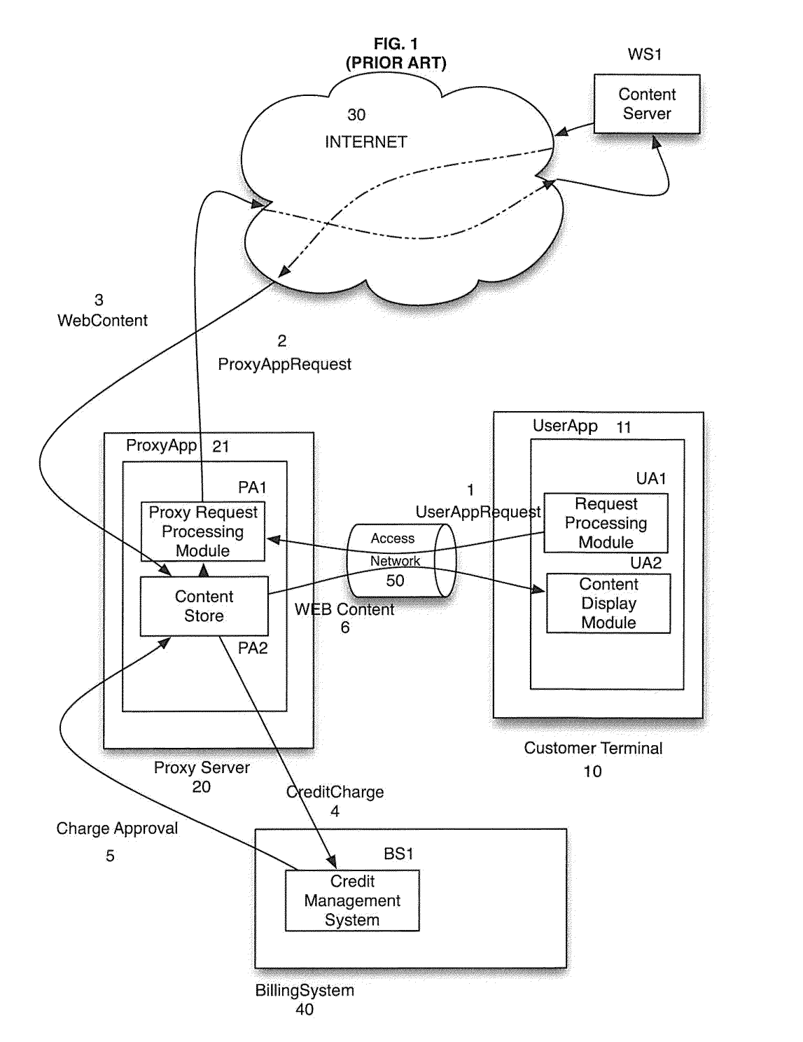

FIG. 1 represents a block diagram of a typical prior art postpaid system in which an Internet Service, Provider (ISP) provides access to content on the Internet to multiple customers. The system includes five distinct sub-systems:

A customer terminal, 10, that can be a personal computer, a tablet, a laptop or a smart phone, etc.

A proxy server, 20, implemented on a single or multiple computers to “impersonate” the customer for managing content requests to the Internet;

A content server (WS1) running specialized software making content accessible to customers from Internet, 30, Using standard Internet protocols or commands issued by the user terminal 10 and processed and negotiated by the proxy server 20;

A billing system, 40, that stores information about activities performed by the customers through the service arid generates appropriate bills to the customers; and

Art access network, 50, (that may include wired and wireless communication paths between the customer terminal TO and the proxy server 20) that the customer “leases” from the ISP in order to gain access to the Internet.

Using the system of FIG. 1, a customer obtains content as follows: In step 1, the customer activates an application 11 (“UserApp”) on the user terminal 10 to access content located on the Internet 30. Examples, of a UserApp are: electronic mail, web browser, twitter client, instant messaging, etc. For the sake of clarity, UserApp 11 is shown with only two components: a request processing module (UA1) and a content display module (UA2). The role of UA1 is to receive and process commands by the customer to the UserApp 10 in order to access content on the Internet. The role of the content display module UA2 is to receive the content provided by the content server WS1, for example, on the customer's display (riot shown).

In this configuration, the role of the proxy server 20 is to act as an intermediary between the customer and the Internet 30. Typically, a proxy server has a large variety of potential purposes, including:

To keep customer terminals and other systems anonymous, mainly for security purposes;

To speed up access to resources (using caching—Web proxies, are commonly used to “cache” web pages from a content server);

To apply access policy to network services or Content (e.g., to block undesired sites);

To access site is prohibited or filtered by your ISP or other Institutions to log/audit usage (e.g., to provide company employee Internet usage reporting);

To bypass security/parental controls;

To circumvent Internet filtering to access content otherwise blocked by governments;

To scan transmitted content for malware before delivery;

To scan outbound content, e.g., for data loss prevention;

To allow a web site to make web requests to externally hosted resources (e.g., images, music files, etc.) when cross-domain restrictions prohibit the web site from linking directly to the outside domains.

A proxy server that passes requests and responses; unmodified is, usually called a “gateway” or, sometimes, a “tunneling” proxy.

A proxy server can be placed in the user's terminal or at various points between the user and the destination servers on the Internet.

The proxy server 20 includes a proxy application 21 with a proxy request processing module PA1 and a web content store PA2.

In step 2, the proxy server 20 sends a proxy request to the content server WS1.

In step 3 the content server WS1 obtains the requested content over the Internet 30 and returns the requested web content to the web content store PA2 in the proxy server 20.

In step 4, a charge associated with the content just obtained is sent to a credit management module BS1 in the billing system 40. The module BS1 determines if the respective customer can be billed for this charge. For example, the module BS1 determines whether or not the charges in the customer's: account have reached a predetermined threshold.

If the charge can be billed, then in step 5 a charge approval, command is returned to the web content store PA2 thereby releasing the content to the customer.

In step 6, the web content is sent through the access network 50 to the content display module UA2 of the customer terminal 10 for presentation to the customer.

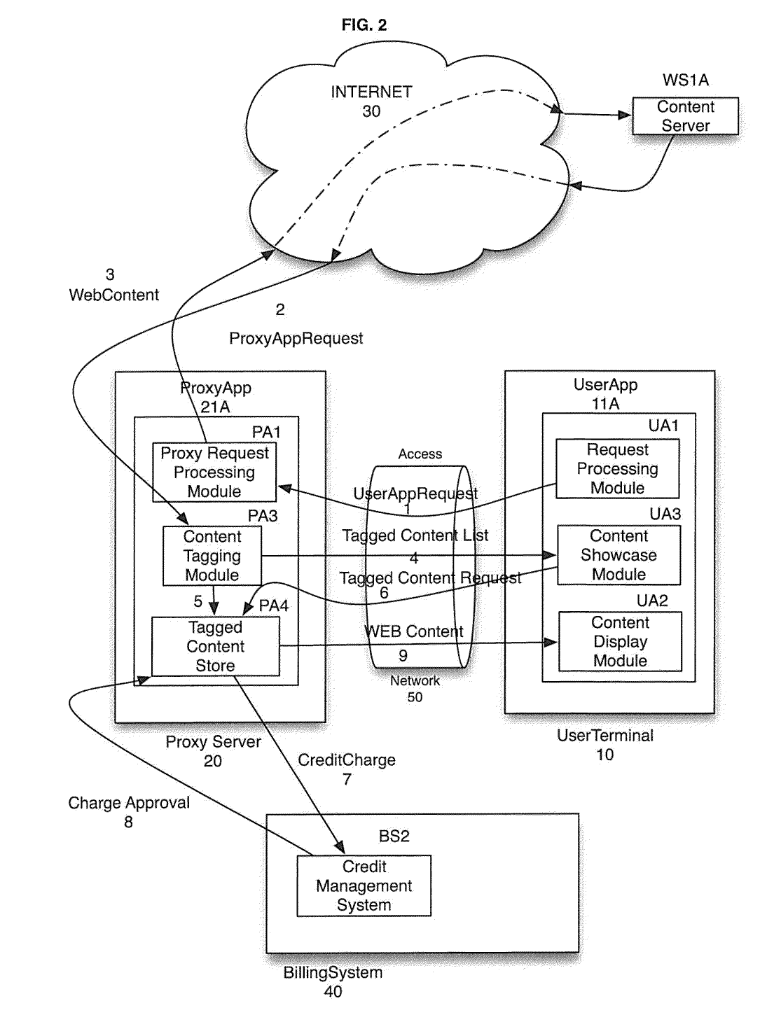

FIG. 2 shows a novel system for providing the customer with the ability to control how and when he/she incurs charges for obtaining content from the Internet. The new system is similar to the prior art system in that it still includes the five subsystems discussed above. However, in this new system, two new modules are introduced: one inside the user application 11A and the other one inside the proxy application 21A. The new module in the UserApp 21A is called a content showcase module UA3. The module in the proxy application 21A is called content tagging module PA3.

As discussed in more detail below, the present invention augments the role of the proxy server 20 by assigning to it the function of examining, classifying and tagging all the components or sections in a WEB page or application before they are downloaded for display to the user on its access terminal. Conversely, the present invention also assigns the function to proxy server 20, through interaction with software preferably located in the request processing module (UA1), of examining, classifying and tagging any content to be sent (uploaded) to the content server. In both instances, e.g., downloading or uploading, the present invention allows the application to know beforehand the cost the customer will incur for the data exchange. In this sense, the present invention empowers the customer to monitor and manage any respective data traffic moving through the access network so that he/she can avoid charges by the ISP for unwanted or non-requested content.

The content tagging module PA3 contains code (instructions) and logic to examine the contents received from the content server in response to a user request before these; contents are downloaded to the user terminal 10. The purpose of this examination, which is very relevant to the present invention, is to tag each section or component of such content with information regarding its type, its intended purpose of use and the amount of data involved.

The content showcase module UA3 in the UserApp 11A works hand in hand with the content tagging module PA3 in the ProxyApp 21A. Its role is to display a summary of all the components of the content being requested by the user from the content server together with their tag information, in such way that the user can decide whether to allow some or all of the components to be downloaded to his access terminal 10 and therefore incur respective charges from the ISP for the use of the access network 50.

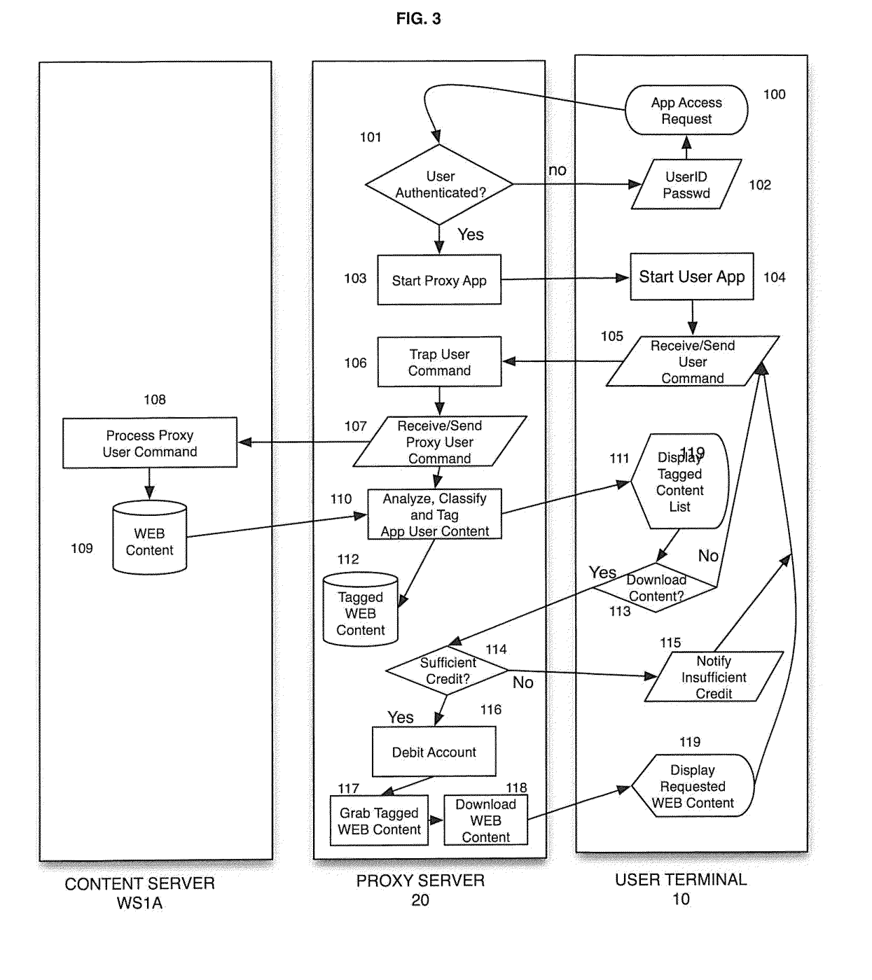

The operation of this novel system is described by means of a flow chart in FIG 3. For the, sake of clarity, the location or site where each respective step is implemented (e.g., the customer terminal 10, proxy server 20 or content server WS1) is also indicated in this figure. In step 100, a customer activates the user application 11A through his customer terminal 10. One such application may be an Email application. In step 101, customer authentication is performed in order to proceed to access the appropriate content source (in this case an Email content server). In step 102, the customer provides a User ID and a password (Passwd) to authenticate himself. Once the authentication attempt succeeds, in step 103, the respective proxy application (in this case, the email proxy) is started. In other words, for this illustration, the user application 11A and the proxy application 21A are both Email applications.

The first action of the Email proxy application 21A upon start-up is to initialize the Email application 11A in the customer terminal 100 in step 104. Once the Email Application 11A is initialized, it enters into step 105, in which it is waiting for customer requests to access the WEB Mail Service WS1A. In step 106, the email proxy application 21A traps the customer command and forwards it to module PA1 which, in step 107, sends the request on behalf of the customer to the Mail Content Server WS1A. In step 108, the content Server processes the request and prepares a query to access the content requested by the proxy server 20 on behalf of the customer. The query is processed in step 109 by gathering all the content relevant to the customer request and sending it to the proxy server 20. Content received by the Email proxy application 21A is processed by the content tagging module PA3 in step 110 in order to examine, Classify and tag every one of the content components. The tag applied to each component includes at the very minimum information required by the Email App 11A to calculate or, at least, estimate bow much the customer will be charged by the service provider to download the content across the access, network 50 to be displayed on the customer terminal 10.

At this stage, since the main objective of the invention is to provide the customer with means to minimize the cost of accessing content on the Internet, the content may be further processed or parsed in order to achieve this end. One example of such processing is compressing the content so that the number of units-of-use transferred over the access network 50 is reduced. In step 111, the content showcase module UA3 of the User App 11A presents to the customer in a clear and organized mariner a list of the different content components and its associated tags. This list needs to be concise in order to minimize the charges by the ISP to download the list itself across the network. For example, in response to an email, another entity may respond with an e-mail that includes the following several components, each haying a certain size, and consequently, an associated cost.

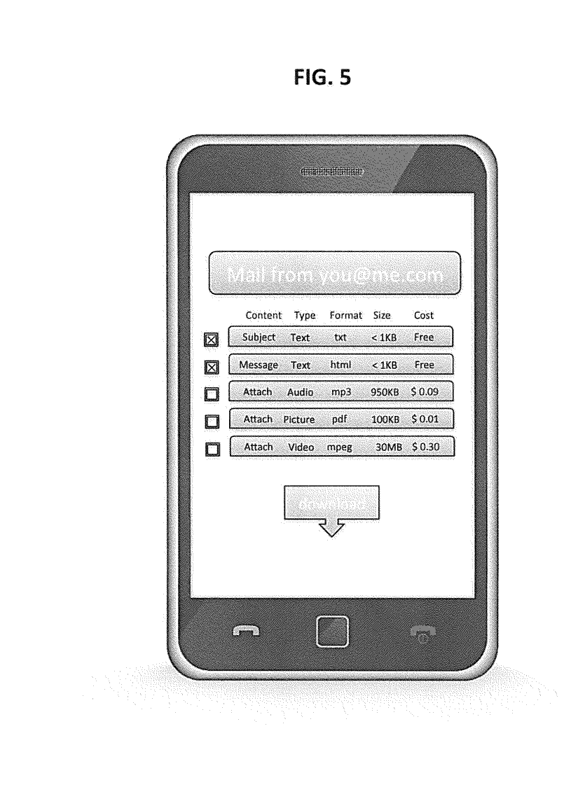

While the content showcase module UA3 is doing its work, step 112 is taking place. In this step 112 the Email proxy app 21A stores locally, in its memory (not shown), the tagged content so it can be promptly accessed if the user decides to proceed with the downloading to its user terminal. FIG. 5 shows the display of the customer terminal 10 listing the components of the tagged content. As can be seen from this figure, the customer is presented for each component a brief description of the content (e.g., subject, message, attachment), the type of information making up the content (e.g., text, audio, video, etc.), the format of the content (e.g., bet, html, mp3, mpeg, etc.), the size of each component, and the cost associated with delivering the respective content component to the customer. For example, the subject and message components are each less then 1 KB and therefore they can be delivered free, the audio attachment is 950 KB and can be delivered for $0.09 and so on. The customer is also provided with a means of selecting the components that he wants to be downloaded, now that he knows the costs involved. For example, in FIG. 5, boxes are provided for each component that can be selectively checked by the customer.

During step 113 the customer reviews the list of content elements or components and based, among other things, on the information furnished with the tags; (and especially the cost associated with downloading the respective component) selects those components to be fully downloaded and displayed on the customer terminal 10. Fig. 5 provides an illustrative example of how these components can be presented. For each component selected for downloading on the access network 50, in step 114 the Proxy App 21A consults the billing system 40 to determine if the customer has enough funds (credit) in his account. If there happens to be enough funds to cover the cost of downloading the component, in step 116 the billing system 40 posts a debit to the customer account arid it adjusts the balance of funds for the respective customer accordingly. Then since the requested components are located, within the ProxyApp memory, in step 117 the components designated by the customer are obtained from the memory:

In step 118 the designated components are sent on the access network 50 to the customer terminal 10. In step 119 the designated components are assembled and displayed for the customer on the customer terminal, screen (not shown). When the funds, in the customer account are insufficient to cover the cost of at least some of the designated components, in step 115 the customer is notified on his terminal 10 that it is riot possible to complete the request due to insufficient funds and he is advised to add more funds to the account and try again.

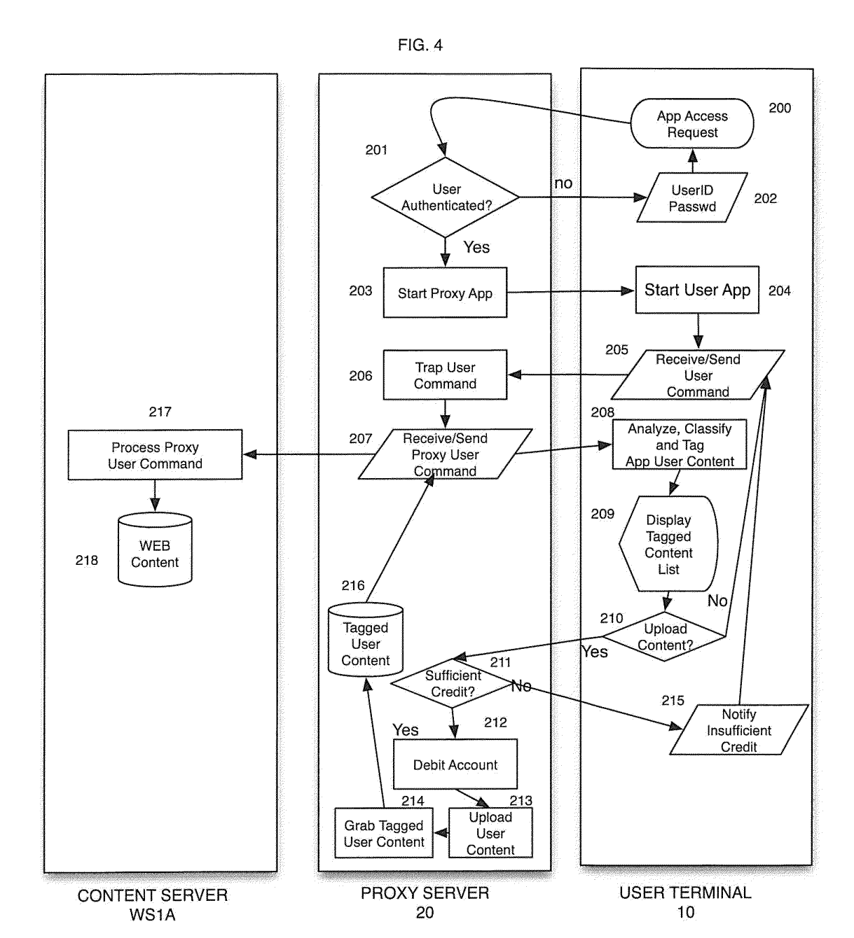

On occasions, in using a User App to interact with a WEB application on the Internet, the customer may need to move content from the customer terminal 100 to a content server located on the Internet. FIG. 4 depicts a flow chart illustrating this process using the system FIG. 2.

In step 200 (FIG. 4), a customer activates an application on his customer terminal 10. One such application may be an Email application. In step 201, customer authentication is performed in order to proceed to access the Email content server WS1A. In step 202, the customer provides a User ID and a password (Passwd) to authenticate himself in the system. Once the authentication attempt succeeds, in step 203, an Email proxy application 21A is started, the first action of the Email proxy application 21A upon start-up is to initialize the Email application 11A on the customer terminal 10 (step 204). Once the Email application 21A is initialized, it enters into step 205, in which it is waiting for customer requests to access the Content Mail server WS1A to be sent upstream to the Email proxy server 20. In step 206, the Email proxy server 20 traps the customer command. But in the present invention, because the command requests that certain content be uploaded to the content Mail server WS1A, in step 208, the Email App 11A processes the request and examines, classifies and tags every one of the user Content components to be uploaded. The tag applied to each component in step 208 includes at the very minimum information required by the Email App 11A to determine or, at least estimate, the cost charged by the ISP to upload the Content across the access network 40 to be processed by the Email proxy App and subsequently sent to the content Email server on the Internet. At this stage, since the main objective of the invention is to provide the customer with means to minimize the cost of accessing content on the Internet, the content may be further processed in order to achieve this end. One example of such processing is compressing the content so that the number of units-of-use to be transmitted on the access network 50 is reduced. In step 209, the content showcase module UA3 presents to the customer in a clear and organized manner a list of the different content components to be uploaded and its associated tags. During step 210, the user reviews the list of content elements and based, among other things, on the information furnished with the tags, selects those elements to be fully uploaded from the customer terminal 10 to the proxy server 20. For each content element selected for uploading across the access network 50, in step 211 the proxy app 21A consults the billing system 40 to determine if the customer has enough funds (credit) in his account to pay for the download of the content elements selected from step 210. If the funds are sufficient to coyer the cost of moving the content across the access network 50, in step 212 the billing system 40 posts a debit to the customer account and it adjusts the balance, of funds. Then in step 213 the requested content components are located within the UserApp memory (hot shown) and they are transported to the Mail proxy app 21A. The process then returns to step 207 in which a request to upload the content is issued by the proxy server App on behalf of the User App 11A to the content server WS1A. The content server processes the request in step 217, and it stores the uploaded content in its memory in step 218. When the available funds are not enough to cover the cost of the transfer operations in step 215 the customer is notified on its customer terminal 10 that it is not possible to complete the request due to insufficient funds and he is advised to top-up the account and try again.

In the detailed exemplary descriptions discussed above, content was exchanged between a customer terminal and a remote server through the Internet using an Email user and proxy applications. Of course, the system works in a similar fashion with other types of applications such as browsers, blogs, twitter accounts, etc. The present inventor contemplates that the customer terminal 10 and the proxy server 20 be equipped with a suite of such applications, with the appropriate application being initiated on demand or in response to commands from the customer.

An abbreviated flow diagram is incorporated in FIG. 2 in order to contrast the process of this invention with the prior art process of FIG. 1. In this FIG. 2, in response to a command from a customer, a user app request (in this case, an email request) is sent from the request processing module UA1 to the proxy server's proxy request processing module PA1 in step 1. In step 2, the proxy request processing module sends a proxy app request to the content server WS1. In step 3, the content server WS1 returns an appropriate web content—in this, case, an email with various attachments.

The web content is received by the content tagging module PA3. Next, the tagging module PA3 analyzes the web content and generates a listing for each of its components, each content component being associated with respective tags, as discussed above and listed in table I. In step 4, a tagged content list with the respective tag is sent to the Content showcase module UA3 of the server 100. At the same time the web content is stored in the tagged content store PA4 in step 5.

The module UA3 then presents the list to the customer. The customer selects the components of interest and the selection results are returned to the content, tagged store PA4 during step 6.

In step 7 a credit charge is sent to the credit management system BS2 which debits the cost of the selected content component(s) in the customer's account and returns a message indicating that charge is approved to the tagged content store PA4. If there are insufficient funds in the customer's account, an appropriate message is sent to the customer (not shown) and/or if the account is set up for automatic refill, the account is replenished from a predetermined credit card or other means.

In step 9 the requested components of the web content are finally presented to the content display module UA2 and/or stored on the user terminal 100 for future viewing.

The descriptions above pertain to the costs of transmitting content to and from a customer, and how a prepaid account established for the customer is used to pay these costs. Of course, in some instances the content source also charges a fee for the content. For example, content server WS2 may be providing a pay-per-view service that streams a desired show for viewing by a customer and charges a fee for each such viewing event. This fee may also be presented to the customer together with the other tags, and if the customer elects to view the show, the appropriate fee is also debited from his account by credit management system BS2.

Thus, the system described can be used for a large variety of content exchanges including downloading or uploading by the customer of movies, books, pictures, files, software products, etc.

The system and process described above is very advantageous in that it provides a means by which a customer of an ISP can exchange content with a remote entity while controlling the costs associated with such exchange. More specifically, each time the customer requests content transfer either to or from the remote entity, he/she is first presented with the actual cost charged by the ISP for the exchange. Moreover, a credit management element is used to establish an account for the customer. If the customer elects to proceed with the exchange, his account is debited with the cost and the transfer is effectuated. As part of the process, the exchange can be effectuated only if the customer's account has sufficient funds for the exchange. If necessary, the account can be replenished manually or automatically through a credit or debit card, a bank account, etc. The system and process are particularly advantageous for customers using mobile devices, such as smart phones, tablets, for content exchange, since the costs of content exchanges over mobile cellular networks can be very high.

The description above provides together with FIGS. 2-5 pertain to one embodiment of the invention. Of course, the invention may be implemented using other embodiments, and the described system could be implemented with other features as well. For example, the content server WS1A may be adapted to provide the content components with tags and the proxy server 20 can be configured to receive a request from content from a customer, and in response, to send a proxyApp request designating only a listing of the components (for example, as presented in FIG. 5). In response the content server WS1A would send to the proxy server, only the listing of the components and not the content itself.

In another embodiment, the content server WS1A could send a message including a head-line style description of the content together with the costs for accessing (e.g., downloading) the whole content, or its various, components.

After the customer indicates which of the components he wants, the proxy server 20 can go back to the server WS1A and request either the whole content or only the components of interest.

In yet another embodiment of the invention, once the content is downloaded into the proxy server, it is cached so that it can be delivered to another customer on request. Of course, in this latter embodiment, provisions must be provided to insure total privacy for both the initial and the latter customer.

In the embodiment described above, the customer must deposit some funds in his account before he can request any content. However, the system and method described do not require prepayment and, accordingly, they can also be used to deliver first content chosen by the customer and then charge him/her later at regular intervals for the content delivered. In this context the notion of “availability of funds” is replaced by “availability of credit”, as determined by the Internet Service Provider and enforced by the Billing System.

Obviously numerous modifications may be made to the invention without departing from the scope of the invention as defined in the appended claims.

I claim:

1. A system for providing web content over the Internet to a user terminal, said user terminal including at least one user application for exchanging web content with a remote content server connected to the Internet, said system comprising:
an access network connected to the user terminal;
a proxy server providing access from said access network to the Internet; and
a billing member coupled to said proxy server, said billing member managing an account associated with the customer;
wherein, in response to, a request for the transfer of the web content by the customer through the user terminal, the proxy server sends a tag to the customer indicating to the customer the costs charged for delivering the web content, and in response to an acceptance by the customer, the proxy server and the billing member cooperate to debit said account with said costs and to deliver said content.

2. The system of claim 1 wherein the; web content is downloaded from the content server to the user terminal.

3. The system of claim 1 wherein the web content is uploaded from the user terminal to the content server.

4. The system of claim 1 wherein said web content includes several components and wherein the customer is presented with a plurality of said tags, each tag including the respective cost associated with transfer of the respective component.

5. The system of claim 1 wherein in response to the request, the web content is transmitted from the content server to the proxy server and the proxy server generates said tag for the user terminal.

6. The system of claim 5 wherein said proxy server includes a proxy request processing application that receives the request and transmits in response a proxy request to the content server.

7. The system of claim 6 wherein said proxy server further includes a content tagging module receiving the web content and generating the tag based on the web content.

8. The system of claim 7 wherein said proxy server includes a content storage receiving and storing the content.

9. The system of claim 1 wherein the user terminal includes a show case module receiving said tag and presenting the tag to the customer.

10. The system of claim 1 wherein the user terminal includes a content display module displaying the content to the customer

11. The system of claim 1 wherein the user terminal is provided with a plurality of user applications; each application being activated selectively by the customer for exchanging respective web content.

12. The system of claim 11 wherein said proxy server includes a plurality of proxy applications, each proxy application corresponding to one of the user applications.

13. The system of claim 1 wherein said access network is a mobile cellular network.

14. A method of providing a content transfer between the user terminal of a customer and a remote content server over the Internet, wherein said user terminal includes a user application for performing content transfer and wherein the customer is associated with a respective account with a prepaid balance, the account being maintained by a billing system, said account comprising the steps of:
transmitting by an access network a request for transfer of web content from the customer to a proxy server;
determining by said proxy server the cost for transmitting said content through said access network;
transmitting by said proxy server a signal to the user terminal, said signal including information indicating said cost for presentation to the customer;
receiving by said proxy server a command from the user to proceed with the transfer;
causing said billing system to debit the account of the customer for the cost; and
effectuating the transfer of the content between the user terminal and the content server through said proxy server.

15. The method of claim 14 wherein the web, content is uploaded from the user terminal to the remote content server.

16. The method of claim 14 wherein the web content is downloaded from the content server to the user terminal.

17. The method of claim 14 wherein the proxy server includes a proxy application, and wherein in response to the request, the proxy application transmits a proxy application request to the content server.

18. The method of claim 17 wherein the proxy server receives the web content in response to the proxy application request.

19. The method of claim 17 further comprising determining said cost based on said web content.

20. The method of claim 19 further comprising the storing said web content on said proxy server.

21. The method of claim 14 wherein said, web content includes several components, each component being associated with a respective cost for exchanging said component over said access network, further transmitting to said user terminal said tags for presentation to the customer.

22. The method of claim 21 further comprising receiving a tagged content request from the user terminal identifying only some of said contents and transmitting by the proxy server only the components corresponding to said tagged content request.

23. The method of claim 14 further comprising accepting prepayment funds by said billing system into said content before content transfer.
